(19) United States
(12) Patent Application Publication
(10) Pub. No.: US 2010/0274922 A1
(43) Pub. Date: Oct. 28, 2010

(54) SYSTEM AND METHOD FOR MANAGING LONG LIVED CONNECTIONS FROM A PLURALITY OF APPLICATIONS RUNNING ON A WIRELESS DEVICE

(76) Inventor: Simon REAVELY, Lexington, MA (US)

Correspondence Address: THORNE & HALAJIAN, LLP, 111 WEST MAIN STREET, BAY SHORE, NY, 11706, US

(21) Appl. No.: 12/750,673

(22) Filed: Mar. 30, 2010

Related U.S. Application Data
(60) Provisional application No. 61/165,390, filed on Mar. 31, 2009.

(51) Int. Cl. G06F 15/173

(52) U.S. Cl. 709/238

(57) ABSTRACT

A proxy server for deploying data content to a plurality of client applications running on a single electronic device, each application being operable to receive on a request basis the data content from a corresponding data service. The proxy server processing a first connection between the electronic device and a first data service for deploying first data content from said first data service to a first client application requesting the first data content via the proxy server, processing a second connection between the electronic device and a second data service for deploying second data content from the second data service to a second client application requesting the second data content via the proxy server.

### FIELD OF THE PRESENT SYSTEM

The present invention relates in general to communications and more specifically to a system and method for managing accesses to data services over long lived connections.

### BACKGROUND OF THE PRESENT SYSTEM

Service providers are beginning to offer more and more communication devices, such as mobile devices, that permit applications to be downloaded to the device by the user. Application development has also been opened up to end users and third parties in some scenarios as well. On some devices multiple applications can be run simultaneously. Application development on mobile phones also now supports HTML/Javascript/CSS/HTTP via WebKit implementations. These trends are set to continue and present some critical challenges for service providers since it removes the service providers typical control on applications. One of the advantages of that historical control has been the ability to predict the quality of service provided by the mobile device while it is running pre-approved (and possibly pre-installed) applications.

Webkit, an open source web browser engine that is capable of running HTML (HyperText Markup Language), Javascript and CSS (Common Channel Signaling) on a device is a good example of a new approach to software (application) development on mobile devices. This approach is more based on desktop approaches than traditional development based on device specific SDKs (Software Development Kit). Some modern browser based applications, also referred to as web based applications, are available to deliver up to the second data content to users. These new approaches make frequent and/or long lived HTTP requests to a server to retrieve real-time data content updates.

A persistent, keep-alive or long-lived connection generally refers to a connection that is not closed (i.e. remains open) after an access request (for a connection) to an application server has been transferred, processed and replied to. An application that supports persistent connections leaves the connection to a corresponding application server open for subsequent requests for data content from this application server. In other words, a connection is “persistent” if it is used for multiple request/response pairs (sometimes just referred to as a request for shorthand).

HTTP (Hypertext Transfer Protocol) is generally favored because this protocol is able to traverse network firewalls and does not require a device to provide inbound access (which is a security risk). While these new approaches work well from a desktop browser, they can quickly lead to scalability issues when used on thin communication devices such as mobile devices. With multiple requests for data content, undesired consequences can be experienced, such as a shorter battery life, unexpected data charges caused by the frequent polling for data, lower real bandwidth as a greater percentage is taken up with communication overheads, less responsive device due to high CPU usage or locked up communications due to limits on the number of simultaneous connections supported.

While solutions can be engineered for a couple of applications, it becomes harder and harder to ensure QoS (Quality of Service) when users are able to make their own decisions on how many applications they can download and run simultaneously on their devices.

FIG. 1A illustrates a known system with a mobile device 100 hosting a plurality of applications, also referred to as client applications here after, running on the device. Conventionally, each client application will establish its own connection to one or more endpoints over a wireless data network 110, thanks to the service provider 120 the mobile device 100 is a subscriber of. These endpoints could be for instance backend web servers in the service provider network 120 or out on the internet 130. The number of connections held across the data network 110 is generally dependent on the number of connections opened by the client applications concurrently to unique endpoints. In the illustration of FIG. 1A, the connections are made via a remote HTTP proxy server 121. The HTTP proxy server 121 will execute the access requests against the target endpoints on behalf of each client application.

In FIG. 1A, three client applications are available for instance on the mobile device 100 and are illustrated as:
an email client application 105, or email application in short, operable to receive data content from a email server 125 hosted by the service provider 120 providing Internet and data access to the mobile device 100,
a stocks feed application 106, operable to receive data content from a stock feed server 126 accessible over the internet 130,
an instant messenger application 107, operable to receive data content from an instant messenger server also accessible over the internet 130.

All client applications may access their target end points through a proxy server 121. Alternatively, the client applications may access the application servers directly. The client applications illustrated in FIG. 1A may be developed independently by different software developers, thus may run without coordination when executed simultaneously. The connections with the endpoints may be for receiving data content as well as additional connections for sending data (e.g. sending instant messages, emails, configuration data, etc).

Many applications written for mobile devices may use web services that communicate with an application server off the device using the HTTP protocol. Client application HTTP requests (for data content from the application server) are usually made over the TCP (transmission control protocol) protocol once a TCP connection has been established with the application server following an access request from the client application. In other words, to make a request, a TCP connection needs to be open. As TCP connections are “expensive” in terms of processing power and latency and therefore web servers often permit the client application to “keep-alive” the connection in between requests; multiple requests to the same server do not require re-establishing of the TCP connection as long as they occur within the server set timeout window. This “persistent connection” may be requested by setting HTTP headers in the request. Persistent connections are supported in the IETF (Internet Engineering Task Force) current developments for HTTP 1.1. HTTP connections are actually persistent connection by default (see IETF Request for Comments RFC 2616). A short lived connection will require a “close” connection token in the header of the HTTP request.

In a persistent connection, the server will control operations by setting headers in the response. Eventually the connections timeout due to inactivity and the client must reestablish the connection. The server also controls (usually through configuration) how many concurrent persistent connections it can support so that it does not exhaust its own resources.

Conventionally for persistent connections, information is requested from a server at the time it is needed by a client application, and the server will produce the requested information on demand. However, there are cases when the client application does not know when information, i.e. results, is available and logically that information needs to be pushed to the client application from the server (server push). It may not be appropriate to have the client application become a server (for example by becoming a socket server) when the application server requires a new TCP connection for pushing the content data. The client application would have to accept request from the remote server when information becomes available, firewalls on the mobile device or a lack of permanent IP address for the mobile being detrimental to the server push. An alternative approach is often referred to as long polling. In desktop/enterprise computing many approaches have been used for server push over HTTP; these include terms/approaches like: Ajax Push, Reverse Ajax, Two-way-web, HTTP Streaming and HTTP server push among others. Long polling does not necessarily need a persistent connection.

Examples of long polling are illustrated in the flowchart of FIG. 1B, that corresponds to the known system of FIG. 1A. In this illustration, the proxy server 121 will proxy the different connection access requests to the application servers 125 to 127 on behalf of respectively the client applications 105 to 107. Once the TCP connections are established (by default persistent connections according to IETF RFC 2616) with their respective applications servers, long polling is used by all three client applications. Looking at the email application 105 in FIG. 1B, an access request will be sent to the email application 105 to the service provider 120 over the wireless data network 110. Proxy server 121 will process the TCP connection with the email server 125 on behalf of the email application 105 (establish connection arrows in FIG. 1B). Long polling is carried out with an HTTP GET request, also called a long lived request, for data content from the email application 105 to the email server 125. The HTTP GET request is processed by the proxy server 121 on behalf of the email application 105. Both access request (TCP level) and HTTP GET request (HTTP level) are illustrated as separate instances (the access request preceding the HTTP request), but may result from one single request or call from the client application (as available today from programming libraries). The connection at the TCP level may be seen as the “carrier” of the data content response from the application server while the http request is the mechanism that causes the response to be sent back to the mobile device.

Once a long lived request has been issued by a client application, and processed by the proxy server 121, that long lived request is pending (referred to as an open long lived request here after) at the proxy server 121 for data content update from the application server.

The long lived HTTP GET, carried over the persistent connection between a client application and an application server, may time out after a given duration depending for instance on the application server. This is illustrated in FIG. 1B both for the stocks feed server 126 and the instant messenger server 127 which send at different instants of time a “time out” message back to their respective client application, through proxy server 121. If data content is available from the application server prior to the HTTP GET request time out, a response or result, namely the newly available data content, will be pushed back to the client application via the proxy server as illustrated with the email server 125. After a time out or the provision of data content, provided the client application still needs updated data content, it will need to reissue an HTTP GET request as the time out or the provision of data content will terminate the open long lived request and consequently the underlying TCP connection. Where the application not to reissue the HTTP GET, the connection between the client application and the proxy server would be released.

In the illustrations of FIGS. 1A and 1B, at least three concurrent persistent connections are maintained between the mobile device and the proxy server. Even though the same connection could be reused after an HTTP GET request time out to avoid TCP handshakes overhead and latencies, each uncoordinated HTTP GET will be using the battery resources of the mobile device. With a large number of client applications available on the device as well as uncontrolled time outs, the burden on the battery resources could be too high for such thin devices.

One possibility to avoid costly HTTP GET calls each time a result is returned is to stream the responses back to the client application. This can be achieved by avoiding completing the HTTP request in the application server. FIG. 1C illustrates the same scenario as in FIG. 1B but with streaming responses. One may notice that there is no need to re-issue the HTTP GET calls when a response is received, as illustrated with the email or instant messenger applications 105 and 107 respectively. A long lived HTTP GET call is only made when a timeout occurs, as with the stocks feed application 106. This approach is limited in use as the client application needs to support streaming responses, which is not a standard across all client applications. Furthermore, the firewalls on service provider networks often include their own timeouts for long lived HTTP GET requests that will force the client applications to re-issue their requests anyway.

If long polling works well on mobile devices because it conserves battery power by not using the radio and CPU as frequently as other approaches, at least one connection is required per client application. As either a) more applications are added onto the mobile device by the mobile owner or b) the complexity of an application is increased, that number of connections needed on the device may further increase.

There is still a need today for an improved and scalable connection management solution that can limit the impact on the mobile device resources. As developers may use their own approach to each client application they develop, there is a further need for a solution that is agnostic to the type of client applications.

### SUMMARY OF THE PRESENT SYSTEM

It is an object of the present system to overcome disadvantages and/or make improvements in the prior art.

The present system includes a system, method, device for deploying data content to a plurality of client applications running on a single electronic device.

The present system includes a proxy server for deploying data content to a plurality of client applications running on a single electronic device, each client application being operable to receive on a request basis said data content from a corresponding data service, said proxy server being arranged to:

process a first connection between the electronic device and a first data service for deploying first data content from said first data service to a first client application requesting said first data content via the proxy server,

process a subsequent connection between the electronic device and a second data service for deploying second data content from said second data service to a second client application requesting said second data content via the proxy server,

said proxy server being further arranged, when identifying that the requests for first and second data content are long lived requests, to:

close the second connection between the electronic device and the proxy server,

route to the electronic device the first and second data content via the first connection left open, when becoming available to the requests respectively for said first and second data content.

Thanks to the present proxy server, the number of open connections and requests is controlled regardless of the number of client applications requesting data content to data services. As a direct consequence, the power resources of the electronic device are spared and the user can enjoy a longer experience with multiple client applications, without the need to recharge the power resources.

The present system also includes method for deploying data content to a plurality of client applications running on a single electronic device, each client application being operable to receive on a request basis said data content from a corresponding data service, said method being carried out by a proxy server and comprising the acts of:

processing a first connection between the electronic device and a first data service for deploying first data content from said first data service to a first electronic client application requesting said first data content via the proxy server,

processing a second connection between the electronic device and a second data service for deploying second data content from said second data service to a second client application requesting said second data content via the proxy server,

and when identifying that the requests for first and second data content are long lived requests,

closing the second connection between the electronic device and the proxy server,

routing to the electronic device the first and second data content via the first connection left open, when becoming available to the requests respectively for said first and second data content.

The present system also includes a computer program stored on a computer readable memory medium, the computer program comprising instructions which, when loaded on a processor of a proxy server, will carry out a method for deploying data content to a plurality of client applications running on a single electronic device, each client application being operable to receive on a request basis said data content from a corresponding data service via said proxy server, said computer program comprising:

instructions for processing a first connection between the electronic device and a first data service for deploying first data content from said first data service to a first electronic client application requesting said first data content via the proxy server,

instructions for processing a second connection between the electronic device and a second data service for deploying second data content from said second data service to a second client application requesting said second data content via the proxy server,

instructions for identifying that the requests for first and second data content are long lived requests, and when said requests for first and second data content are long lived requests:

closing the second connection between the electronic device and the proxy server,

instructions for routing to the electronic device the first and second data content via the first connection left open, when becoming available to the requests respectively for said first and second data content.

The present system also related to an electronic device for deploying data content to a plurality of client applications running on said electronic device, each client application being operable to receive on a request basis said data content from a corresponding data service, said electronic device hosting a micro server proxy arranged to:

intercept a first request from a first client application to a first data service for deploying first data content from said first data service to said first client application requesting said first data content,

notify a proxy server to process a first connection between the electronic device and the first data service for deploying the first data content for the first request,

intercept a second request from a second client application to a second data service for deploying second data content from said second data service to said second client application requesting said second data content

notify the proxy server to process a second connection between the electronic device and the second data service for deploying the second data content for the second request,

listen to the first connection for data content when being notified that the second connection is closed,

notify the proxy server of a further request for data content on behalf of a client application when receiving on the first connection data content identified as a response to an intercepted request from said client application.

The present system also relates to system for deploying data content to a plurality of client applications running on a single electronic device, said system comprising:
a plurality of application servers hosting each a data service for providing dating content to client application running on an electronic device requesting said data content,
an electronic device hosting a plurality of client applications, each client application being operable to receive on a request basis the data content from a corresponding data service, said electronic device hosting a micro server proxy arranged to:
   intercept a first request from a first client application to a first data service for deploying first data content from said first data service to said first client application requesting said first data content,
   notify a proxy server to process a first connection between the electronic device and the first data service for deploying the first data content for the first request,

intercept a second request from a second client application to a second data service for deploying second data content from said second data service to said second client application requesting said second data content

notify the proxy server to process a second connection between the electronic device and the second data service for deploying the second data content for the second request,
a proxy server arranged to:
   process the first connection when notified by the electronic device of the request for first data content,
   process the second connection when notified by the electronic device of the request for second data content,
   said proxy server being further arranged, when identifying that the requests for first and second data content are long lived requests, to:
   close the second connection between the electronic device and the proxy server,
   route to the electronic device the first and second data content via the first connection left open, when becoming available to the requests respectively for said first and second data content,
      the electronic device being further arranged to:

listen to the first connection for data content when being notified that the second connection is closed,

notify the proxy server of a further request for data content on behalf of a client application when receiving on the first connection data content identified as a response to an intercepted request from said client application.

### BRIEF DESCRIPTION OF THE DRAWINGS

The invention is explained in further detail, and by way of example, with reference to the accompanying drawings wherein:

FIGS. 1A to 1C show an exemplary embodiment of a known system for deploying data content to a mobile device as well as corresponding message flow charts;

FIG. 2 shows an electronic device in accordance with an embodiment of the present system;

FIG. 3 shows a system for deploying data content to a mobile device in accordance with an embodiment of the present system;

FIG. 4 shows a process flow diagram illustrating an exemplary embodiment of the present method,

FIG. 5 shows a message flow chart in accordance with another embodiment of the present system; and,

FIG. 6 shows a system in accordance with another embodiment of the present system.

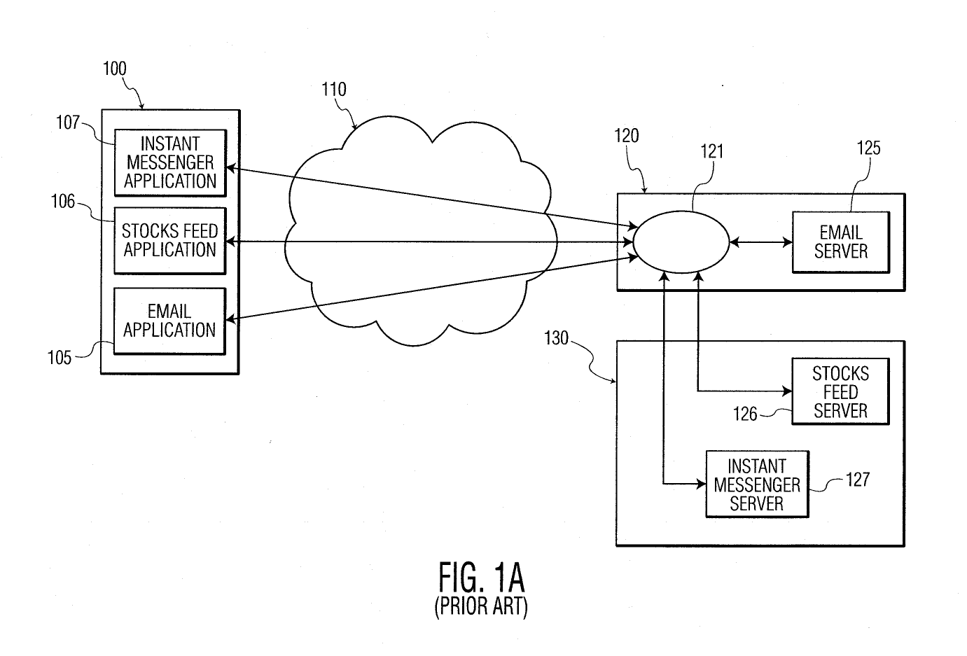

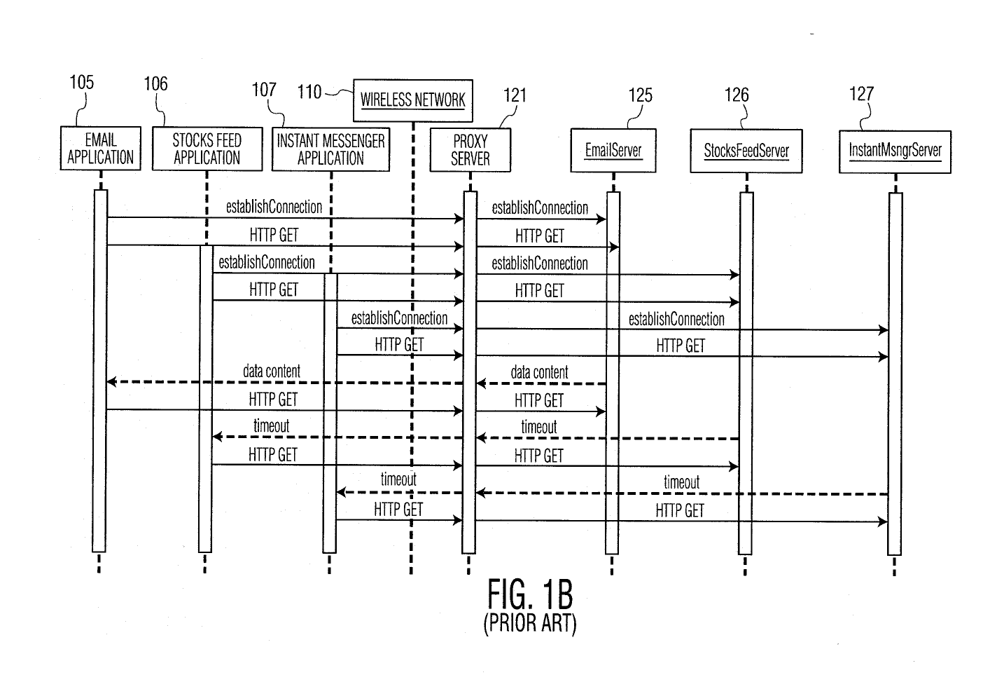

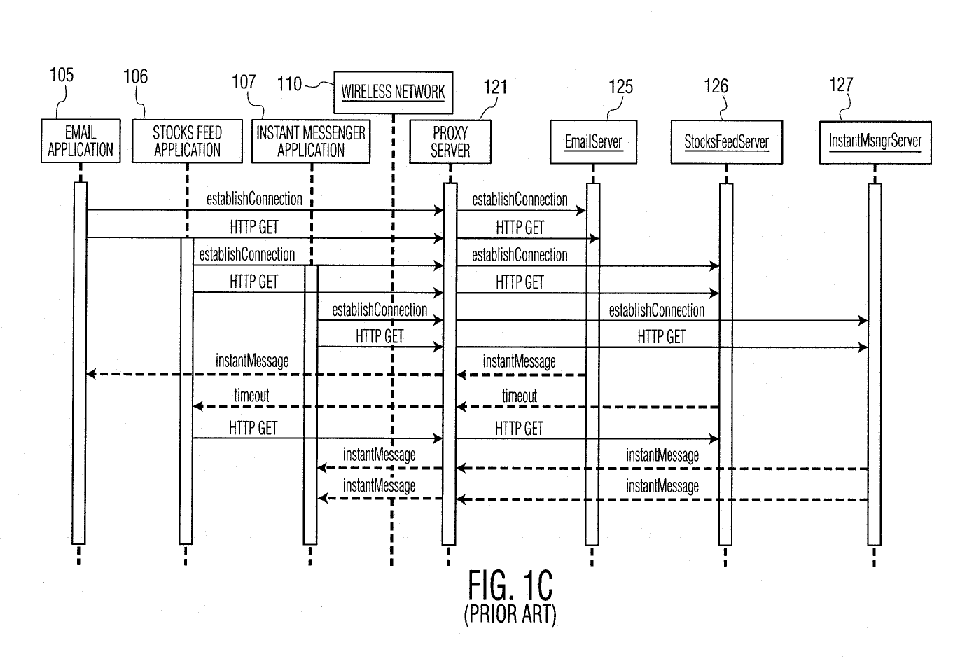

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between a data service, namely the application server hosting this service, and one or more user devices. A further operative coupling, in accordance with the present system may include one or more couplings between a user device and a proxy server handling connection request on behalf of client applications hosted by the user device. An operative coupling may also relate to an interaction between program portions and thereby may not describe a physical connection so much as an interaction based coupling.

In addition, it should be expressly understood that the drawings are included for illustrative purposes and do not represent the scope of the present to system.

The system, device(s), method, user interface, etc., described herein address problems in prior art systems. In accordance with an embodiment of the present system, a system provides an improved management of persistent connections and requests for data content between a user device, illustrated here after as a mobile device, and applications servers providing this data content to client applications hosted by the mobile device.

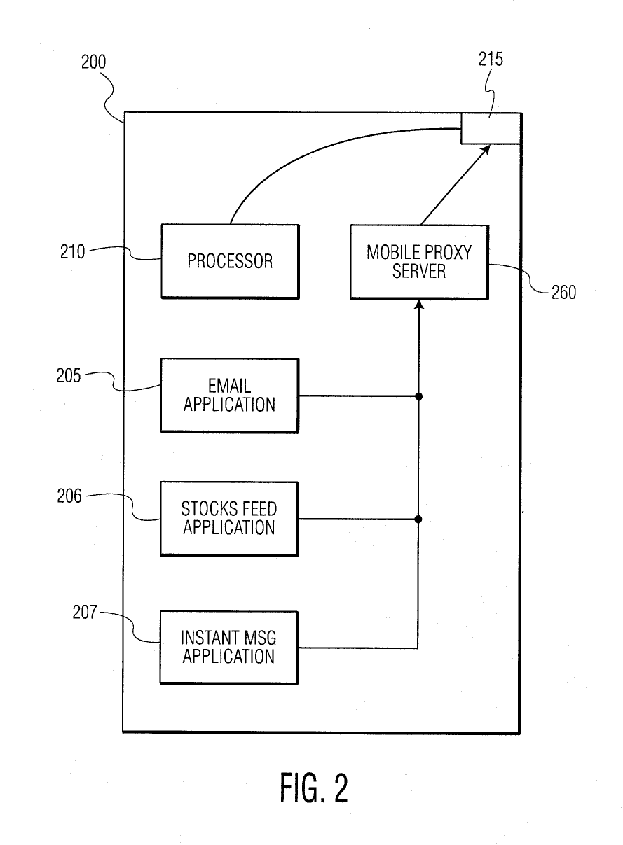

FIG. 2 is an illustration of an exemplary user device 200 used in the present system. The user device 200 comprises a display device (not shown), a processor 210, a (mobile) proxy micro server 260, an input device (not shown) for interacting with the mobile device and a plurality of client applications, illustrated here after as an email application 205, a stocks feed application 206 and an instant messenger application 207.

In the description here after, a client application, or web application, is an application program or software that may be seen as any tool that functions and is operated by means of the user device processor 210 and that interacts over data connection (e.g. the internet or a private network) with an application server off the device 200. This application server hosts a data service that deploys data content to the client application either over persistent and/or non persistent connections. To that extend, the mobile device 200 also comprises one or more connection interfaces 215 for connecting over a communication network with the application server. A web application may request for data content through HTTP request as described with known systems.

A proxy micro server 260, executing on the processor 210 of the mobile device 200, is also provided. Such micro servers are known from the Applicant's pending US 2007197230. Micro server 260 may be seen as a common interface for multiple applications and/or functions of mobile device 200. The micro server (or other comparable software) is capable of, inter alia, receiving and processing information from other functions, both internal and external to the mobile device. In an exemplary embodiment of the present system, this processing includes, for example, capturing access requests from the client applications and processing connections to the application servers with an off device proxy server. Processing by the micro-server also may include receiving data content from the application servers and forwarding the received data content to the right client application. As it processes access request on behalf of the client applications, the micro server 260 can be seen as a local proxy server between these client applications and other entities (off device application servers) and networks.

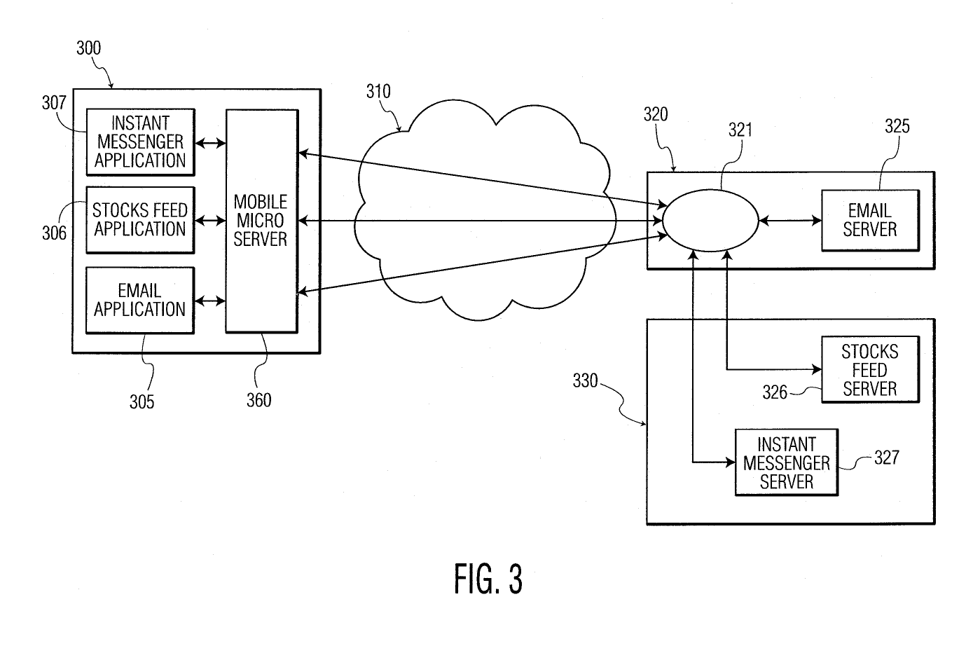

FIG. 3 is an illustration of an exemplary embodiment of the present system. A mobile device comprises:
an email application 305, operable to receive data content from an email server 325 hosted by the service provider 320 providing internet and data access to the mobile device 300,
a stocks feed application 306, operable to receive data content from a stock feed server 326 accessible over the Internet 330,
an instant messenger application 307, operable to receive data content from an instant messenger server also accessible over the internet 330.

A proxy micro server 360, also referred to as mobile micro server here after, is also provided for implementing an exemplary embodiment of the present method. As in previous illustrations, a proxy server 321 is also provided within the service provider network 320 for:
processing/handling access requests from client applications, i.e. forming/establishing a connection between the mobile device and a corresponding application server, and;
processing/handling requests for data, for instance through the HTTP GET request, for collecting updates from the application servers.

In the present system, once a first request for data from a first client application has been identified as a long lived request, the proxy server will know that for any subsequent request for data from another client application that is identified also as long lived, it will route the updates to both applications through only one connection maintained open between the proxy server 321 and the mobile device 300. That unique connection is the first connection formed with the first request for data from the first application. In other words, when the proxy server 321 identifies, i.e. is instructed (via the header) or detects (via its timeout for the request), that the request is long lived, then any response will be channeled on the open long lived request (made optionally on a persistent connection).

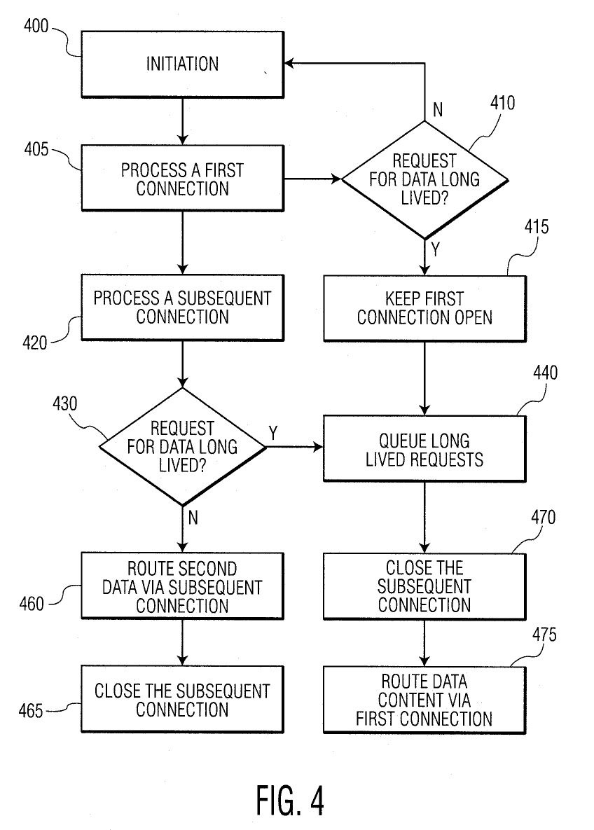

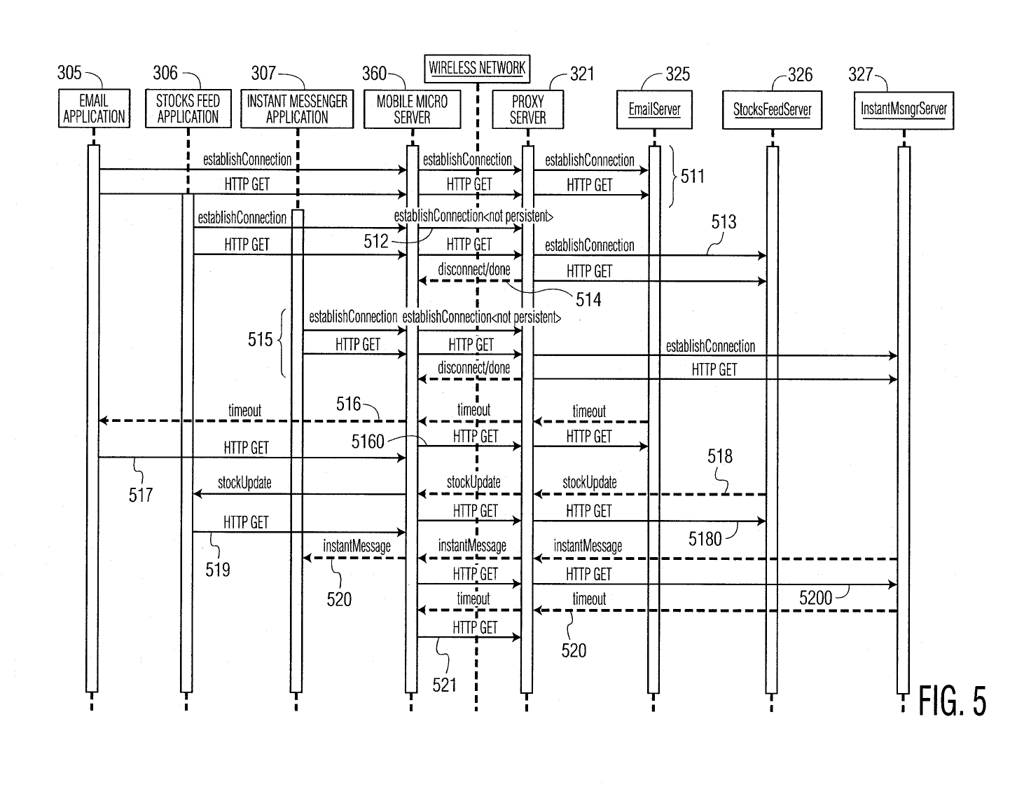

FIG. 4 is an illustrative process flow diagram of an embodiment of the present method, as seen by the proxy server 321. FIG. 4 will be described here after in conjunction with FIG. 5 showing a message flow chart between the different entities or parts of FIG. 3, namely the client applications 305 to 307, their respective application servers 325 to 327, the proxy server 321, the mobile micro server 360 and the wireless communication 310. In the hereafter description in relation to FIGS. 4 and 5, reference will be made to the TCP (for connection) and HTTP (for requests) protocols.

The proxy server 321 is arranged for deploying data content to a plurality of client applications all running on the mobile device 300, each client application being operable to receive on a request basis, e.g. through HTTP GET request, data content from a data service hosted by an application server.

In a preliminary act 400, the mobile micro server 360 will intercept a first request for update from a first client application, for instance the email application 305, to a corresponding service data, here the email server 325. As mentioned before, the request for update, for instance an HTTP request, may be preceded by, or formulated within the same call with, an access request for forming a TCP connection. The micro server 360 will notify the proxy server 321 to form a first connection, for instance a TCP connection, between the mobile device 300 and the email server 325 on behalf of the email application that made the request for update.

The proxy server 321 will process a first connection in a further act 405 between the mobile device 300 and the email server 325, for deploying first data content from the email server 325 to the email application 305. Thanks to that first connection, the mobile device is now listening for data content updates from the email server 325, via the proxy server 321. This act 405 of FIG. 4 corresponds to acts 501 in FIG. 5, illustrated with the first HTTP GET request from the email application 305.

In a further act 410, proxy server 321 will verify whether this first HTTP GET is a long lived request or not. In order to provide transparency to client applications using the present system, both proxy server 321 and mobile micro server have to support all HTTP requests, i.e. both long-lived and short-lived/regular requests. In an additional exemplary embodiment of the present system, proxy server 321 is arranged to assume that all requests from a client application and notified by the micro server 360 are short lived. Proxy server may then set a timer TIMER_LL for each notified request to monitor whether this notified request is long lived or not. As the proxy server 321 will proceed with the first connection to the application server once notified with the request, it will identify the request as short lived if a response from the application server is received before the timer timeouts (answer NO to act 410). Proxy server 321 will return the response back to the mobile device 300 and may close the connection. The present method will resume at the initial act 400.

When identifying that the request for update is a long lived request, i.e. that the timer runs out before any response from the application server is received, proxy server 415 will keep the first TCP connection open. In a further act 440, the proxy server 321 will await for a further response from the email server. In other words, the long lived HTTP request may be queued in a long lived request queue of pending HTTP requests, in the present illustration as the first entry to that queue. Any subsequent response from the email server 325 will be returned by the proxy server 321 back to the mobile device 300.

Thanks to a timer for identifying whether a request for update is a long lived or short lived request, the client applications making the request remain agnostic to the type of request. The type of request, as in current HTTP protocol development, is decided by the application server behavior.

In an alternative embodiment to the timer on the proxy server 321, a dedicated header may be provided in the HTTP request. The client application will allocate such a header to its request to indicate that a long lived request. A timer is no longer needed in the proxy server. Upon reading the header in the HTTP request, the proxy server 321 will instantly identify the HTTP request as long lived, and queue it in the long lived request queue.

In a further act 420, another client application, for instance the stocks feed application 306, will require an update for data content (HTTP GET request of act 513 in FIG. 5). The micro server 360 will intercept the corresponding second request for update. Provided another request is still running, i.e. pending in the long lived request queue of the proxy server 321, presently the first request, the micro server 360 will notify the proxy server 321 to manage requests for update for the second application 306 (stock feeds). In order to form a subsequent connection between the mobile device and the stocks feed server 326, the micro server 360 will notify the proxy server to process, i.e. form, that subsequent connection (acts 512 and 513 in FIG. 5). As with the email application, the proxy server 321 will process a second, i.e. subsequent, connection between the mobile device 300 and the stocks feed server 326, for deploying second data content from the stocks feed server 326 to the stocks feed application 306.

In an additional embodiment of the present method, the proxy server 321 may verify whether this second HTTP GET is a long lived request or not, either through a header in the request or through a second timer run by the proxy server 321. If the second HTTP GET is identified as a short lived request (answer NO to act 430), the result provided by the stocks feed server, if any (result may not be provided by the stocks feed server, even if the request is tagged with a header as short lived), will be routed back to the mobile device through the second connection in a further act 460 and the second connection closed (act 465).

When the proxy server 321 identifies the second HTTP GET as a long lived connection (answer YES to act 430), the second HTTP GET request will be queued in the long lived request queue of the proxy server. As that queue now comprises two pending HTTP requests, the proxy server is now waiting for data content (updates) from both the email server 325 and stocks feed server 326.

In a further act of the present method, once both the first and second HTTP GET requests have been identified as long lived requests, i.e. both queued in the long lived request queue in act 440, the subsequent (second) connection between the proxy server 321 and the mobile micro server 360 will be closed, leaving only the portion of the connection between the proxy server and the stocks feed server 326 open. As the proxy server 321 is now connected to both the email and stocks feed servers, and listening for updates, it will in an additional act 475 route any data content from either application server to the mobile device via the first connection left open, i.e. persistent. As the mobile micro server 360 is notified that the second connection has been closed, it will listen for updates on the first connection left open.

The same acts 420 to 465 may be carried out for a third connection resulting from a request for update (a third HTTP GET of act 515 in FIG. 5) from the instant messenger application 407. Provided the third HTTP GET is also a long lived request, the third TCP connection will be closed in act 470, and the proxy server will route any data content from either application server to the mobile device via the open persistent connection (first TCP connection).

The proxy server has now waiting for updates from the three application servers 325, 326 and 327. In other words, three open (i.e. pending for results) HTTP GET (1) are waiting in the long lived request queue of the proxy server 321 for updates from either application server. The three applications illustrated on the mobile server could be qualified as being in their stable bootstrapped state as they are all ready to receive updates pushed from any server.

The present proxy server may be operable to handle requests for update from a plurality of mobile devices hosting themselves a plurality of client applications. In order to sort out the different notifications to form a connection from the plurality of mobile devices, the proxy server may keep track per mobile device of which connection and HTTP GET requests have been processed. When receiving a notification for a connection, it will indeed identify the mobile device sending the notification, and check whether a request for update has already been processed for this mobile device. Thus the proxy server can identify if this is a first or subsequent HTTP GET and/or notification for a connection from this mobile device.

As explained before, pending long lived request may time out on the application server side before any update becomes available. The proxy server may also have its own timeout for long lived request.

When a timeout is received by the proxy server 321 from the email server 325 for instance, it will be forward to the mobile micro server 360 using the open first connection (act 516 in FIG. 5). The initial HTTP GET from the email application 305 is not longer pending in the long lived request queue of the proxy server 321.

As one of the open HTTP GET request has expired (i.e. between the email application 305 and its application server 326 in the illustration of FIG. 5), a direct consequence is that now the TCP connection between the email server 325 and the mobile device 300 may be terminated by the proxy server 321. Indeed the HTTP GET has been completed by the email server 325. Consequently, the first connection would not longer allow any data content results from the other HTTP GET requests left open in the long lived request queue (the stocks feed and instant messenger requests) to be forwarded to the requesting client applications.

As a solution to this problem, in an additional exemplary embodiment of the present system, the mobile micro server 360 will reissue over the first connection an HTTP GET request on behalf of the email application 305 without waiting for that application to process the timeout message. The reissued HTTP GET (act 5160 of FIG. 5) will be intercepted by the proxy server 321 and forwarded to the email server 325. The new open HTTP GET 5160 will be handled by the proxy server 321 as in act 420 of FIG. 4, i.e. as if another client application (here the email application 305) has required an update for data content (as with the HTTP GET request of act 513 in FIG. 5). As at least one request is still pending in the long lived request queue (actually two in the exemplary embodiment of FIG. 5) of the proxy server 321, the proxy server 321 is notified thereby to manage (again) requests for update for the email application 305. The new open HTTP GET 5160 has now replaced the one that timed out and the proxy server 321 is listening again to the email server 325 as long as the other application servers 326 and 327.

Once the email application 305 gets the time out message from the mobile micro server 360, provided it still needs data content updates from the email server 325, it will reissue an HTTP GET (act 517 in FIG. 5) as that application is not aware that the mobile micro server 360 has already reissued that same request. The HTTP GET 517 becomes a void operation. Thanks to that void operation, the mobile micro server 360 will however note that the email application 305 has made a request for data content. This may be used as an aliveness indicator showing that the client application is still expecting a response, confirming that the mobile micro server 360 should carry one managing the connection to the email server via the proxy server 321.

In an additional exemplary embodiment of the present system, the handling of a data content result from an application server will be processed by the proxy server 321 and the mobile micro server 360 in the same manner a time out is handled. In other words, the acts 516, 5160 and 517 for the time out handling will correspond respectively to acts 518, 5180 and 519 for the data content results in FIG. 5.

For instance, when a data results from the stocks feed server 326 is received by the proxy server 321 (stock update message 518 in FIG. 5), it will be forwarded to the mobile micro server 360 using the open first connection. As the initial HTTP GET from the stocks feed application 306 is not longer pending in the long lived request queue of the proxy server 321, a direct consequence is that now the TCP connection between the stocks feed server 326 and the mobile device 300 may be terminated by the proxy server 321, preventing the mobile device 300 from getting data content results from the other open HTTP GET requests in the long lived request queue (the email and instant messenger requests).

In an additional exemplary embodiment of the present system, the mobile micro server 360 will reissue over the first connection an HTTP GET request on behalf of the stocks feed application 306 without waiting for that application to process the stocks feed update. The reissued HTTP GET (act 5180 of FIG. 5) will keep the first connection open and allow the proxy server 321 to listen to all three application servers. As with the new open HTTP GET 5160 (following the time out) described here before, the new open HTTP GET 5180 (following the stocks feed update) will be handled by the proxy server 321 as in act 420 of FIG. 4.

Once the stocks feed application 306 gets the update message 518 from the mobile micro server 360, provided it still needs data content updates from the stocks feed server 326, it will reissue an HTTP GET (act 519 in FIG. 5) as that application is not aware that the mobile micro server 360 has already reissued that same request. The HTTP GET 519 becomes a void operation, i.e. an aliveness indicator as with the HTTP GET 517 following the time out message described here before.

After receiving a time out or update message from the mobile micro server 360, an application may shut down; either turned off by the user of mobile device 300 or when updates are no longer needed. Say the instant messenger server sends results back to the instant messenger application 307 (instant message 520 in FIG. 5). As with the previous time out 516 and stock update message 518 of FIG. 5, the mobile micro server 360 will reissue an HTTP GET (act 5200 in FIG. 5) on behalf of the instant messenger application 307, as explained before, to keep the connection open. This time, as the instant messenger application shut down, it will not reissue the “void” HTTP GET itself following the instant message passed on by mobile micro server 360. As a consequence, the aliveness indicator for the instant messenger application 307 has not been issued, thereby signaling to the mobile micro server 360 that this application no longer needs results. Once the new HTTP GET 5200 times out (act 520 in FIG. 5), mobile micro server 360 will process the time out message differently as it is already aware of the instant messenger application shut down. Indeed, mobile micro server will discard the time out message as its recipient, the instant messenger application 327, is no longer available.

A specific HTTP GET request will be reissued, to keep the first connection between mobile micro server 360 and mobile proxy 321 open, but this specific HTTP GET (act 521 of FIG. 5) will notify the proxy server 321 not to reestablish the request to the instant messenger server 327.

If subsequently a request is made again from the instant messenger application 327, that request will be handled by the mobile micro server 360 and the proxy server 321 as if it was a subsequent request for update from a client application (from 420 in the illustration of FIG. 4).

In an additional exemplary embodiment of the present system, provided streaming is handled by the client applications, i.e. streaming responses, the present teachings may be used, without the need to reissue a new HTTP GET systematically.

The mobile micro server 360 of the present system may act like a conventional HTTP proxy server with some special functions for managing long lived requests for multiple servers as required across the applications on a mobile device:
it will maintain an association between the mobile device 300, its client applications and the proxy servers that it may proxy with,
when a data content update, i.e. a response, is received from any of the application servers that are being proxied by the proxy server 321 for the mobile device 300, it is arranged to identify the open request corresponding to the received response, and forward that response to the client application that made the open request,
it is further arranged to maintain the requests providing a client application has not shut down (new HTTP GET), and keep track of any aliveness indicator were a client application not responding to a time out or update message.

In the present illustration, reference was made to a single proxy server 321. A plurality of proxy servers may be available to the mobile micro server 360 to proxy the request for data content. Each proxy server will then process as described in relation to FIGS. 4 and 5 for these requests it receives notification of by mobile micro server 360 of the mobile device 300. As such several proxy servers may be involved in the management of the requests for data content. One TCP connection will then be formed and maintained per involved proxy server.

In order to find a proxy server, mobile micro server 360 may be configured the address of the most relevant proxy server. Mobile micro server 360 may be operatively coupled to a proxy server finder module, either hosted by the mobile device itself or hosted in the service provider network 320. When queried, the finder module would return to the mobile micro server 360 the relevant proxy server to use. For instance, the finder module answer could be based:

a) on the location of the mobile device i.e. the finder module would return a proxy server physically closer to the mobile device,

b) on QoS related issues, such as returning a proxy server that is not saturated with traffic,

c) on configuration rules relevant to the mobile micro server 360.

In the present system, the mobile micro server 360 will intercept the original HTTP request (when a new client application is seeking a data content update) and proxy it to the proxy server 321, and notify all original HTTP requests to the proxy server no matter what IP address or target endpoint each client application “thinks” it is sending the original request to.

The following exemplary embodiments are illustrations of possible mobile micro server implementations. A general goal of these exemplary embodiments is to make the integration of mobile micro server 360 as seamless as possible to the client application, thereby avoiding significant changes to existing client applications

In a first exemplary embodiment of the mobile micro server, for client applications that already support configuration of a HTTP proxy, the mobile micro server would masquerade as a conventional web proxy. The mobile micro server would have a local address (e.g. 127.0.0.1) and port number.

In a second exemplary embodiment of the mobile micro server, a new Javascript API could be created for use by client applications that utilize XMLHTTPRequest via Javascript for communication with off device application servers. The new API would redirect the requests to the local mobile proxy, i.e. mobile micro server 360, instead of communicating directly with the target endpoint.

In a third exemplary embodiment of the mobile micro server, in order to cater for the J2ME (Java Platform, Micro Edition) user, a new J2ME API would be created as a wrapper around the existing HttpConnection API. J2ME programmers could also use the mobile micro server directly via the standard MIDP (Mobile Information Device Profile) HTTP connection class.

In a fourth exemplary embodiment of the mobile micro server, a change of the IP stack in the HTTP requests from the client applications could be performed. This embodiment would introduce support within the Internet layer by tunneling all requests to the mobile micro server without any changes required to the application on the device i.e. the application would be unaware of the existence of the mobile micro server, in a similar way to how a Virtual Private Network (VPN) works.

The proxy server may be arranged to multiplex the data content updates prior to routing the updates back to the mobile device and the mobile micro server. When information is received by the mobile micro server, it will be demultiplexed to the correct requesting client application.

In the present illustrations, reference was made to a mobile device. The present method is particularly well suited to such devices as the single connection and the reduced number of HTTP GET request will alleviate the load on the mobile device power resource. The present teaching may also be implemented to an electronic device hosting a number of client applications and in communication with off device endpoints through a service provider network.

One may note that although HTTP GET requests are used in the present illustrations, other HTTP methods such as POST would naturally be supported for deploying the data content updates. Furthermore, the proxy server 321 and the mobile micro server 360 may support secure HTTP request, i.e. HTTPS to permit secure communications on behalf of a client application to an endpoint.

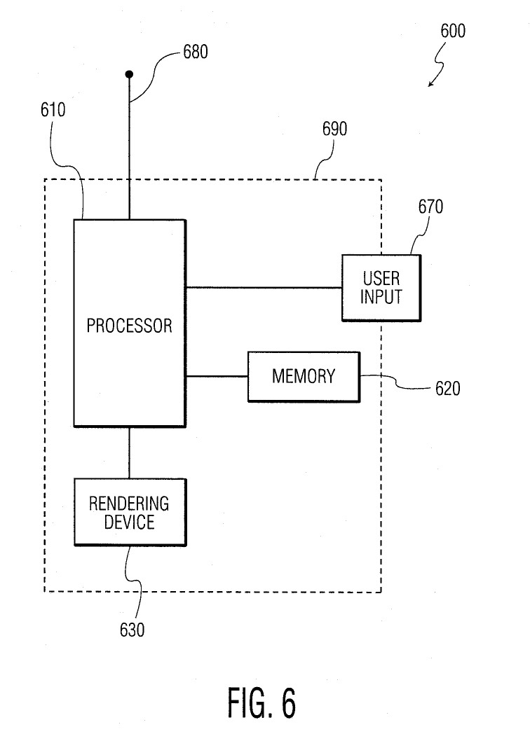

FIG. 6 shows a system 600 in accordance with an embodiment of the present system. The system 600 includes a device 690 (e.g. proxy server or mobile micro server) that has a processor 610 operationally coupled to a memory 620, a rendering device 630, such as one or more of a display, speaker, etc., a user input device 670, such as a sensor panel, a keyboard, trackball and the likes, and a connection 640 operationally coupled to other entities and servers of service provider 320 (e.g. the application servers, the proxy server when the device 690 is the mobile device and reversely). The connection 640 may be an operable connection between the device 690 and another node or server that has similar elements as device 690, such as the application servers.

The memory 620 may be any type of device for storing for instance the application data related to the operating system of the device 690, as well as to application data in accordance with the present method. The application data are received by the processor 610 for configuring the processor 610 to perform operation acts in accordance with the present system. The operation acts include the identifying that the requests for first and second data content are long lived requests; route the second data content when provided by the second data service to the mobile device via the first connection and close the subsequent connection.

The user input 670 may include a sensor panel as well as a keyboard, mouse, trackball, touchpad or other devices, which may be stand alone or be a part of a system, such as part of a personal computer (e.g., desktop computer, laptop computer, etc.) personal digital assistant, mobile phone, converged device, or other rendering device for communicating with the processor 610 via any type of coupling, such as a wired or wireless coupling. The user input device 670 is operable for interacting with the processor 610 including interaction within a paradigm of a GUI and/or other elements of the present system, such as to enable entry of data by an operator or user.

Clearly the service node 690, the processor 610, memory 620, rendering device 630 and/or user input device 670 may all or partly be portions of a computer system or other device, and/or be embedded in one or more servers.

The system, device and method described herein address problems in prior art systems. In accordance with an embodiment of the present system, the proxy server and the mobile micro server will interact with each other in accordance with the present system so as to offer an improved deployment of data content to client applications running on the mobile device hosting the mobile micro server. As may be readily appreciated, the mobile device may also include a corresponding processor, memory, rendering device, user input device and operable coupling as the proxy server and as such, the description of operation, etc. of the proxy server should be understood to encompass a description of illustrative operable portions of the mobile device, suitably coupled and configured for operation in accordance with the present system.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 620 or other memory coupled to the processor 610.

The computer-readable medium and/or memory 620 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling, etc. Any medium known or developed that can store and/or transmit information suitable for use with a computer system may be used as the computer-readable medium and/or memory 620.

Additional memories may also be used. These memories configure processor 610 to implement the methods, operational acts, and functions disclosed herein. The operation acts may include identifying that the requests for data content are long lived requests.

Moreover, the term “memory” should be construed broadly enough to encompass any information able to be read from or written to an address in the addressable space accessed by a processor. With this definition, information on a network is still within memory 620, for instance, because the processor 610 may retrieve the information from the network for operation in accordance with the present system. For example, a portion of the memory as understood herein may reside as a portion of the call control node, and/or the user device.

The processor 610 is capable of performing operations in response to notifications from the mobile micro server to form the first and subsequent connections. The processor 610 may be an application-specific or general-use integrated circuit(s). Further, the processor 610 may be a dedicated processor for performing in accordance with the present system or may be a general-purpose processor wherein only one of many functions operates for performing in accordance with the present system. The processor 610 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. Thus, while the present system has been described with reference to exemplary embodiments, including user interfaces, it should also be appreciated that numerous modifications and alternative embodiments may be devised by those having ordinary skill in the art without departing from the broader and intended spirit and scope of the present system as set forth in the claims that follow. Further, while exemplary user interfaces are provided to facilitate an understanding of the present system, other user interfaces may be provided and/or elements of one user interface may be combined with another of the user interfaces in accordance with further embodiments of the present system.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A proxy server for deploying data content to a plurality of client applications running on a single electronic device, each client application being operable to receive on a request basis said data content from a corresponding data service, said proxy server being arranged to:
process a first connection between the electronic device and a first data service for deploying first data content from said first data service to a first client application requesting said first data content via the proxy server,
process a subsequent connection between the electronic device and a second data service for deploying second data content from said second data service to a second client application requesting said second data content via the proxy server,
said proxy server being further arranged, when identifying that the requests for first and second data content are long lived requests, to:
close the second connection between the electronic device and the proxy server,
route to the electronic device the first and second data content via the first connection left open, when becoming available to the requests respectively for said first and second data content.

2. The proxy server according to claim 1, said proxy server being further arranged, when identifying that the second request is a short lived request, to:
route second data content, if any, from the second data service to the electronic device via the second connection,
close the second connection between the electronic device and the proxy server.

3. The proxy server according to claim 1, said proxy server being further arranged to:
route to the electronic device a timeout message via the first connection left open, when either request for data content hits a data service timeout,
maintain the first connection open when identifying a second request for data content received from the electronic device, said second request being either due to the routed data content or to the routed timeout.

4. A method for deploying data content to a plurality of client applications running on a single electronic device, each client application being operable to receive on a request basis said data content from a corresponding data service, said method being carried out by a proxy server and comprising the acts of:
processing a first connection between the electronic device and a first data service for deploying first data content from said first data service to a first electronic client application requesting said first data content via the proxy server,
processing a second connection between the electronic device and a second data service for deploying second data content from said second data service to a second client application requesting said second data content via the proxy server,
and when identifying that the requests for first and second data content are long lived requests,
closing the second connection between the electronic device and the proxy server,
routing to the electronic device the first and second data content via the first connection left open, when becoming available to the requests respectively for said first and second data content.

5. The method according to claim 4, said method further comprising when identifying that the second request is a short lived request, the acts of:
routing second data content, if any, from the second data service to the electronic device via the second connection,
closing the second connection between the electronic device and the proxy server.

6. The method according to claim 4, said method further comprising the acts of:
routing to the electronic device a timeout message via the first connection left open, when either request for data content hits a data service timeout,
maintaining the first connection open when identifying a second request for data content received from the electronic device, said second request being either due to the routed data content or to the routed timeout.

7. A computer program stored on a computer readable memory medium, the computer program comprising instructions which, when loaded on a processor of a proxy server, will carry out a method for deploying data content to a plurality of client applications running on a single electronic device, each client application being operable to receive on a request basis said data content from a corresponding data service via said proxy server, said computer program comprising:
instructions for processing a first connection between the electronic device and a first data service for deploying first data content from said first data service to a first electronic client application requesting said first data content via the proxy server,
instructions for processing a second connection between the electronic device and a second data service for deploying second data content from said second data service to a second client application requesting said second data content via the proxy server,
instructions for identifying that the requests for first and second data content are long lived requests, and when said requests for first and second data content are long lived requests:
closing the second connection between the electronic device and the proxy server,
instructions for routing to the electronic device the first and second data content via the first connection left open, when becoming available to the requests respectively for said first and second data content.

8. An electronic device for deploying data content to a plurality of client applications running on said electronic device, each client application being operable to receive on a request basis said data content from a corresponding data service, said electronic device hosting a micro server proxy arranged to:
intercept a first request from a first client application to a first data service for deploying first data content from said first data service to said first client application requesting said first data content,
notify a proxy server to process a first connection between the electronic device and the first data service for deploying the first data content for the first request,
intercept a second request from a second client application to a second data service for deploying second data content from said second data service to said second client application requesting said second data content
notify the proxy server to process a second connection between the electronic device and the second data service for deploying the second data content for the second request,
listen to the first connection for data content when being notified that the second connection is closed,
notify the proxy server of a further request for data content on behalf of a client application when receiving on the first connection data content identified as a response to an intercepted request from said client application.

9. A system for deploying data content to a plurality of client applications running on a single electronic device, said system comprising:
a plurality of application servers hosting each a data service for providing dating content to client application running on an electronic device requesting said data content,
an electronic device hosting a plurality of client applications, each client application being operable to receive on a request basis the data content from a corresponding data service, said electronic device hosting a micro server proxy arranged to:
intercept a first request from a first client application to a first data service for deploying first data content from said first data service to said first client application requesting said first data content,
notify a proxy server to process a first connection between the electronic device and the first data service for deploying the first data content for the first request,
intercept a second request from a second client application to a second data service for deploying second data content from said second data service to said second client application requesting said second data content
notify the proxy server to process a second connection between the electronic device and the second data service for deploying the second data content for the second request,
a proxy server arranged to:
process the first connection when notified by the electronic device of the request for first data content,
process the second connection when notified by the electronic device of the request for second data content,
said proxy server being further arranged, when identifying that the requests for first and second data content are long lived requests, to:
close the second connection between the electronic device and the proxy server,
route to the electronic device the first and second data content via the first connection left open, when becoming available to the requests respectively for said first and second data content,
the electronic device being further arranged to:
listen to the first connection for data content when being notified that the second connection is closed,
notify the proxy server of a further request for data content on behalf of a client application when receiving on the first connection data content identified as a response to an intercepted request from said client application.

10. A micro server proxy for deploying data content to a plurality of client applications running on an electronic device hosting said micro server proxy, each client application being operable to receive on a request basis said data content from a corresponding data service, said micro server proxy arranged to:
intercept a first request from a first client application to a first data service for deploying first data content from said first data service to said first client application requesting said first data content,
notify a proxy server to process a first connection between the electronic device and the first data service for deploying the first data content for the first request,
intercept a second request from a second client application to a second data service for deploying second data content from said second data service to said second client application requesting said second data content
notify the proxy server to process a second connection between the electronic device and the second data service for deploying the second data content for the second request,
listen to the first connection for data content when being notified that the second connection is closed,
notify the proxy server of a further request for data content on behalf of a client application when receiving on the first connection data content identified as a response to an intercepted request from said client application.
